(19) United States
(12) Patent Application Publication
(10) Pub. No.: US 2022/0395008 A1
(43) Pub. Date: Dec. 15, 2022

(54) GLUCOSE-CONTAINING SWEETENING MIXTURE

(71) Applicant: BM HEALTH GMBH, Wien (AT)

(72) Inventor: Christian R. NOE, Wien (AT)

(73) Assignee: BM HEALTH GMBH, Wien (AT)

(21) Appl. No.: 17/775,741

(22) PCT Filed: Nov. 10, 2020
(86) PCT No.: PCT/EP2020/081591

§ 371 Date: May 10, 2022

(30) Foreign Application Priority Data
Nov. 12, 2019 (AT) A50962/2019

(51) Int. Cl. A23L 27/30; A23L 2/60; A23L 21/10; A23F 3/14

(52) U.S. Cl. CPC A23L 27/33; A23L 2/60; A23L 21/10; A23F 3/14; A23V 2002/00

(57) ABSTRACT

The invention relates to a glucose-containing sweetening mixture, comprising or consisting of glucose and at least one glucose-free sweetener, wherein the sweetening mixture has a sweetness between 3.0 and 5.0, in particular between 3.5 and 4.5. The invention further relates to a food product containing this sweetening mixture.

### CROSS-REFERENCE TO RELATED APPLICATION(S)

This application is the National Stage of International Patent Application No. PCT/EP2020/081591 filed on Nov. 10, 2020, which claims priority from Austrian Patent Application No. A50962/2019 filed on Nov. 12, 2019, both of which are herein incorporated by reference in their entireties.

### BACKGROUND

The present invention relates to a glucose-containing sweetening mixture.

More than half of the population in industrial nations suffer from overweight. It is known that excessive sugar intake is one of the most significant factors for overweight, which subsequently has a negative impact on the general health and life expectancy of the persons concerned. As a result, cardiovascular diseases occur, which are the most common cause of death. The use of sucrose (sugar) to sweeten food is widespread. Sucrose is the main component of cane sugar or beet sugar and some other sugars obtained from natural raw materials. Many convenience foods, such as yogurts, cocoa or mueslis, contain a high proportion of sugar, as do desserts. In particular, beverages such as sodas often contain high concentrations of sucrose (often 50 to 120 g/L).

The use of calorie-free sweeteners is considered one of the most efficient measures to reduce overweight. Such complete replacement of sugar by sweeteners is also very common in beverages (e.g. Zero-Cola). One of the disadvantages of sweeteners is that they often have an unpleasant aftertaste for the consumer, so that the taste impression of the food product is not the same as when the usual household sugar (sucrose) is used.

A side effect of much greater relevance is the now well-known effect, confirmed by animal experiments, that the regular intake of “zero-sugar products” in no way leads to weight loss, but on the contrary to weight gain. The craving for food (“sugar craving”) is held responsible for this. The cause of this craving is an irritation of the brain. The receptors of the sense of taste tell the brain that food has been ingested. The perception of the sweet taste ultimately means not least a reward for the intake of particularly good food. After all, the brain depends on glucose as its only immediate source of energy. The brain is the largest consumer of glucose in the human body and requires an average of about 200 g of glucose per day. The brain is damaged after only a few minutes of glucose absence.

Food intake is regulated in the brain by the hypothalamus. This has several receptors for glucose. Only when the ingested glucose arrives directly at the hypothalamus is the feeling of satiety triggered. However, if no glucose arrives at the hypothalamus after the ingestion of sweeteners, then no feeling of satiety is triggered. It is quite understandable that the control system of the hypothalamus raises the alarm and gets out of control if, despite announcement by the glucose receptors on the tongue, no molecular glucose arrives in the end. Sugar craving is triggered.

In principle, the addition of sucrose to sweeteners could avoid sugar craving because it contains glucose. Ultimately, however, sucrose is unsuitable as a means of reducing overweight. It is a disaccharide consisting of a glucose unit and a fructose unit. In the human body, sucrose undergoes enzymatic cleavage into the monosaccharides glucose and fructose. The glucose subsequently passes directly into the blood and is used primarily for the immediate energy supply of the body, especially the brain and the red blood cells, which depend on the supply of glucose as an energy source. The correlation between sucrose intake and overweight can be explained in particular by the fact that the fructose component of sucrose is broken down in the liver after intake and transferred to the fat metabolism. In the case of nutrient excess or lack of exercise, respectively, the result is an excessive accumulation of storage fat in the body and overweight. In addition, fructose has a negative effect on lipoprotein metabolism.

Since glucose is not transferred to the fat metabolism, it is possible to use it as a sucrose substitute. In fact, however, glucose, which is available for sale, has not become widely accepted as a sweetener, firstly because its sweetness is significantly lower than that of sucrose, and secondly because the taste of products sweetened with glucose is rather stale and does not get close to that of sucrose.

### SUMMARY

The necessity of supplying glucose to the brain to prevent sugar craving, achieving a pleasant taste sensation of sweetened foods, and avoiding metabolization of sucrose into the fat metabolism can be regarded as objectives to be solved by the present invention. This makes the compounds according to the invention particularly suitable as weight loss agents (“anti-obesity”). They can perfectly replace conventional sweeteners by providing glucose to the body at the same time.

By means of physiological tests, it was surprisingly found that by combining sweeteners with glucose, on the one hand, glucose loses its rather stale taste and, on the other hand, the unpleasant aftertaste of sweeteners can be largely suppressed.

Thus, the object of the present invention can be seen in creating a sweetening mixture which efficiently promotes the reduction of overweight, which is able to provide glucose to the human brain, which at the same time imparts a pleasant natural sweetness and does not have the unpleasant taste of known sweeteners.

In the context of the present invention, the term “sweetness” refers to the ability of a substance or a mixture of several substances to induce a subjective sensation of sweetness. The unit of sweetness is widely used in food technology. It is determined in physiological dilution tests and is a relative unit based on sucrose, sucrose having a sweetness of 1.

A fictitious substance with a sweetness of 2 is therefore twice as sweet as sucrose. This means that only half the amount of this substance is needed to produce the same sweetness as sucrose. In practice, the sweetness of substances is determined in the prior art, for example, by forming aqueous solutions and comparing them with sucrose solutions.

Since the sweetness of sweeteners is much higher than that of glucose, it is possible, as a rough approximation, to produce sweetened glucose by adding sweeteners to glucose, the sweetness of which is several times that of sucrose depending on the amount of sweetener added. The limiting factor here is the minimum proportion of glucose required to obtain a sweetened glucose with a pleasant taste comparable to sucrose.

The invention relates to a glucose-containing sweetening mixture, comprising or consisting of glucose and at least one calorie-free and/or glucose-free sweetener.

The object of the invention is solved by the features of the independent patent claim. According to the invention, it is provided that the sweetening mixture has a sweetness between 3.0 and 5.0, in particular between 3.5 and 4.5.

For example, a serving of about 1 g of a sweetening mixture of the present invention having a sweetness of about 4.0 provides substantially the same sweetness as a serving of about 4 g of sucrose, with the 1 g serving of the sweetening mixture providing about half the glucose equivalents compared to the 4 g serving of sucrose.

The present inventor has surprisingly found that a sweetening mixture containing glucose and having the sweetness according to the invention has a pleasant taste, i.e., neither the unpleasant taste of pure sweeteners nor the stale taste of pure glucose, and, in addition, is capable of providing vital glucose to the brain. Due to the very low content of glucose, these mixtures are ideal for the purpose of calorie reduction as a sweetener and as an ingredient in food products. In addition, the mixture has a significantly lower calorific value compared to an amount of sucrose that would be required to achieve a comparable glucose concentration in the body.

The invention relates to a glucose-containing sweetening mixture, comprising or consisting of glucose and at least one glucose-free sweetener.

Optionally, it is provided that the sweetening mixture has a sweetness between 3.0 and 5.0, in particular between 3.5 and 4.5.

Optionally, it is provided that the sweetening mixture has a calorific value of 13.0 to 16.0 kJ/g.

Optionally, it is provided that the sweetening mixture is free of other metabolizable carbohydrates, in particular free of monosaccharides and disaccharides.

Optionally, it is provided that the sweetening mixture is sucrose-free and/or fructose-free.

Optionally, it is provided that the glucose-free sweetener is selected from sodium cyclamate, sodium saccharin, aspartame, acesulfame, aspartame-acesulfame salt, stevioside, neohesperidin DC, thaumatin, neotame, advantame, mogroside or any mixture thereof

Optionally, it is provided that the sweetening mixture contains 94.96 wt.-% glucose, 4.2 wt.-% sodium cyclamate and 0.84 wt.-% acesulfame K.

Optionally, it is provided that the sweetening mixture contains 98.36 wt.-% glucose, 0.82 wt.-% aspartame and 0.82 wt.-% acesulfame K.

Optionally, it is provided that the sweetening mixture contains substantially calorie-free excipients, such as fillers, binders, preservatives, or drying agents.

Optionally, it is provided that the sweetening mixture exists as powder, syrup, or compressed tablet.

Further, the invention relates to a food product containing a glucose-containing sweetening mixture according to the invention.

Optionally, it is provided that the food product contains 5 to 20 g/kg, preferably 15 to 20 g/kg, of the sweetening mixture.

Optionally, it is provided that the food product is a beverage.

Optionally, it is provided that the food product is substantially sucrose-free and/or fructose-free.

Optionally, it is provided that the calorific value of the food product is 80 to 320 kJ/kg, preferably 240 to 320 kJ/kg.

In glucose-containing sweetening mixtures according to the invention, neither another carbohydrate used for sweetening nor the sweetener sucralose, which consists of chlorinated sucrose, is added as sweetener, since such compounds may affect the metabolism and the signal paths of the glucose.

In the context of the present invention, the terms “free of” or “-free” mean that no substantial amounts of the designated substance are present in a mixture or in a food product or a blend. No or undetectable amounts of this substance may be present, or contents of no more than 1 wt.-% are also possible, since such small amounts do not contribute significantly to the calorific value of a food product. For example, “fructose-free” can thus mean that up to at most 1 wt.-% fructose is contained in a sweetening mixture or in a food product.

The agents according to the invention are also perfectly suitable for sweetening products containing natural glucose, such as jams, syrups and the like, because unnecessary additional fructose intake is avoided.

In the context of the present invention, the term “calorie-free” may mean that certain components of a mixture are not metabolizable by the human body and therefore have no significant calorific value. More particularly, the term “metabolism” and variations thereof refer to the possibility of metabolism by the human body.

The sweetening mixture according to the invention can be used for sweetening food products. Another aspect of the present invention relates to the use of a sweetening mixture according to the invention for diagnostic purposes, for example, to diagnose the uptake of glucose into the brain.

In particular, the sweetening mixture of the present invention contains about half of the glucose and/or glucose equivalents compared to that amount of sucrose that would be required to provide a comparable sweetness. “About half” in this context preferably means providing between 40% and 60%, more preferably between 45% and 55% of the glucose equivalents.

Optionally, it may be provided that the sweetening mixture of the present invention has a GSV value between 0.15 and 0.35 to quantify the glucose to sweetener ratio (Glukose-Süβstoff-Verhältnis, GSV). More preferably, it may be provided that the sweetening mixture of the present invention has a GSV value between 0.20 and 0.30. Even more preferably, it may be provided that the sweetening mixture of the present invention has a GSV value between 0.22 and 0.27, or a GSV value of about 0.25.

For the purposes of the present invention, the GSV value refers to the ratio of the glucose and/or glucose equivalents contained in the sweetening mixture to the sweetness.

In particular, the GSV value may be calculated according to the following formula:

$$GSV = \frac{{m}_{Glu}}{{m}_{total}} / SK$$

wherein m_{Glu} is the mass of glucose and/or glucose equivalents contained in the sweetening mixture, mₜₒₜₐₗ is the total mass of the sweetening mixture, and SK is the sweetness of the sweetening mixture.

According to the above-mentioned details, sucrose has a GSV value of about 0.53.

A glucose equivalent in the sense of the present invention means a unit in a compound equivalent to a glucose molecule. For example, sucrose as a disaccharide consists of a glucose unit and a fructose unit. Thus, 1 g of sucrose contains about 0.53 g of glucose equivalents.

Further optional features of the invention arise from the patent claims and the exemplary embodiment of the invention.

In the following, the invention will be described in detail with reference to exemplary embodiments.

### DETAILED DESCRIPTION OF THE PREFERRED EMBODIMENTS

### EXAMPLE 1

### Glucose-Containing Sweetening Mixtures According to the Invention

Testing compared to sucrose: In a series of tests, the sweetening mixtures shown in Table 1 below were tested and found to be equivalent in taste to a solution containing four times the amount of sucrose. The sweetening mixtures contain one sweetener (mixture No. 1-4) or two sweeteners (mixture No. 5-8).

For testing, a solution of 5 g of a sweetening mixture according to the invention was prepared in 300 mL of tap water.

TABLE 1

| Mix- | | Percent- | | Percent- | |
|---|---|---|---|---|---|
| ture | | age | | age | Sweet- |
| No. | Sweetener 1 | (wt.-%) | Sweetener 2 | (wt.-%) | ness |
| 1 | Acesulfame K | 1.58 | — | — | 3.1 |
| 2 | Aspartame | 2.66 | — | — | 4.7 |
| 3 | Aspartame | 2.40 | — | — | 4.3 |
| 4 | Stevia | 1.34 | — | — | 4.7 |
| 5* | Stevia | 0.80 | Thaumatin | 0.08 | 3.3 |
| 6* | Acesulfame K | 0.82 | Aspartame | 0.82 | 3.3 |
| 7* | Acesulfame K | 0.84 | Sodium cyclamate | 4.20 | 3.2 |
| 8 | Aspartame | 0.70 | Sodium saccharin | 0.35 | 3.3 |

*These mixtures were judged to have excellent taste in the tests

All mixtures in Table 1 contain glucose as the remainder to 100 wt.-%. Inevitable impurities may be present.

The mixtures listed in Table 1 have the following GSV values (rounded to two decimal places): Mixture 1—0.32, mixture 2—0.21, mixture 3—0.23, mixture 4—0.21, mixture 5—0.30, mixture 6—0.30, mixture 7—0.30, mixture 8—0.30.

### EXAMPLE 2

### Glucose-Containing Iced Tea with Particularly Low Calorie Content

In a further series of tests, two sweetening mixtures according to the invention were compared to pure sweetener and pure sucrose (comparative examples). First, the sweetening mixtures according to the invention were prepared by manually grinding the individual components. The compositions are listed in wt.-% in Table 2 below. Based on the sweetness of the individual components reported in the literature, the sweetness of the respective mixture was calculated and is also shown in Table 2. About 100 g of each mixture was prepared.

TABLE 2

| | Mixture 9 | Mixture 10 | Mixture | Mixture |
|---|---|---|---|---|
| | (comparative) | (comparative) | 11 | 12 |
| Sucrose | 100 | — | — | — |
| Glucose | — | — | 97.9 | 95.5 |
| Sodium | — | 90 | 1.5 (71%) | 4 (89%) |
| cyclamate | | | | |
| Sodium | — | 10 | 0.6 (29%) | 0.5 (11%) |
| saccharin | | | | |
| Sweetness | 1 | 71 | 3.8 | 4.1 |

The above mixtures were used to sweeten a black tea extract to form an iced tea beverage. All four beverages were sweetened with appropriate amounts of the mixture according to their sweetness to achieve a comparable impression of sweetness. The amounts of the mixtures used are shown below in Table 3.

Mixture 9 from Table 2 was used to prepare beverage 1, mixture 10 for beverage 2, mixture 11 for beverage 3, and mixture 12 for beverage 4.

The four beverages prepared in this way were cooled to a drinking temperature of approximately 10 ° C. and subjected to blind tasting with 10 participants. Participants were asked to rate the taste of the beverage on an integer scale from 1 to 5 (1=very good to 5=poor). The average value of the ratings is given in Table 3.

TABLE 3

| | Beverage 1 | Beverage 2 | Beverage | Beverage |
|---|---|---|---|---|
| | (comparative) | (comparative) | 3 | 4 |
| Amount of the | 64.0 | 1 | 17.0 | 15.7 |
| mixture (g/L) | | | | |
| Evaluation | 1.5 | 3.2 | 1.7 | 1.4 |
| Calorific | 1075 | 0 | 272.8 | 240.4 |
| value (kJ/L) | | | | |
| Sugar | 64.0 | 0 | 16.6 | 15.0 |
| equivalents | | | | |
| (g/L) | | | | |

In Table 3, it can be seen that beverages 3 and 4 sweetened with the mixtures according to the invention received a similar evaluation to beverage 1 sweetened conventionally with sucrose. In particular, most participants indicated that it was not possible for them to distinguish the beverages according to the invention from the conventional sweetening method (sucrose).

On the other hand, beverage 2 with the synthetic sweetener was rated significantly worse, especially due to the aftertaste of the sweetener.

In addition, the approximate calorific values per litre, as well as the sugar equivalents contained, were calculated for the beverages produced. For the calculation of the calorific value, it was approximately assumed that the added carbohydrates (sucrose for beverage 1 and glucose for beverages 2-4) represent the only carbohydrate source.

When calculating sugar equivalents, it is indicated how much sugar a corresponding beverage can provide.

The test results show that the sweetening mixtures according to the invention are superior to conventional sweetening methods, since sufficient amounts of glucose are provided to supply the brain, the excessive intake of fructose is avoided and the subjective taste impression is comparable to that of sucrose.

In the second embodiment, the sweetening mixtures shown in Table 4 were also evaluated. It was indicated by the participants that all of the mixtures shown in Table 4 were usable in sweetening foods, in particular beverages. (analogous to Beverage 1 from Table 3) was distinguishable.

TABLE 4

| | Sweetness of | Wt.-% | Sweetness of the |
|---|---|---|---|
| Sweetener | the sweetener | Sweetener | sweetening mixture |
| Aspartame* | 140 | ~2.3 | 3.8 |
| Acesulfame K* | 200 | ~1.6 | 3.8 |
| Steviol glycosides | 250 | ~1.3 | 3.9 |
| Mogroside | 250 | ~1.3 | 3.9 |
| Aspartame- | 350 | ~0.9 | 3.8 |
| acesulfame salt* | | | |
| Neohesperidin DC | 600 | ~0.5 | 3.7 |
| Thaumatin | 2500 | ~0.13 | 4.0 |
| Neotame* | 7000 | ~0.05 | 4.2 |
| Advantame* | 37000 | ~0.01 | 4.4 |

*These sweetening mixtures provided particularly good test results in terms of taste perception.

### EXAMPLE 3

### Sweetened Jam

An apricot jam was prepared according to the following recipe using a ratio of glucose to sweeteners according to the invention:

Ingredients:
500 g apricots
100 g sweetening mixture (glucose/sodium cyclamate/sodium saccharin)
10 g pectin
5 g citric acid

Preparation:

Washed, chopped fruit is mixed with the sweetening mixture, pectin and citric acid, brought to the boil and boiled for approx. 5 minutes (until gelling test is positive) with gentle bubbling and constant stirring, and then bottled.

The jam was tested comparatively with a jam made according to the same recipe with 400 g sucrose. With a slight change in consistency, the jam according to the invention was found to have an excellent taste, which was at least equivalent to that of the jam made with sucrose.

The jam was tested comparatively with another jam prepared according to the same recipe with 400 g glucose. With a slight change in consistency, the jam according to the invention was found to have an excellent taste, while the jam made with pure glucose had a much poorer taste.

1. A glucose-containing sweetening mixture, comprising glucose and at least one glucose-free sweetener, wherein the sweetening mixture has a sweetness between 3.0 and 5.0.

2. The glucose-containing sweetening mixture according to claim 1, wherein the sweetening mixture has a calorific value of 13.0 to 16.0 kJ/g.

3. The glucose-containing sweetening mixture according to claim 1, wherein the sweetening mixture is free of monosaccharides and disaccharides.

4. The glucose-containing sweetening mixture according to claim 1, wherein the sweetening mixture is free of at least one of sucrose and fructose.

5. The glucose-containing sweetening mixture according to claim 1, wherein the glucose-free sweetener is selected from sodium cyclamate, sodium saccharin, aspartame, acesulfame, aspartame-acesulfame salt, stevioside, neohesperidin DC, thaumatin, neotame, advantame, mogroside or any mixture thereof

6. The glucose-containing sweetening mixture according to claim 1 wherein:
the sweetening mixture contains 94.96 wt.-% glucose, 4.2 wt.-% sodium cyclamate and 0.84 wt.-% acesulfame K, or
the sweetening mixture contains 98.36 wt.-% glucose, 0.82 wt.-% aspartame and 0.82 wt.-% acesulfame K.

7. The glucose-containing sweetening mixture according to claim 1, wherein the sweetening mixture contains at least one calorie-free excipient.

8. The glucose-containing sweetening mixture according to claim 1 wherein the sweetening mixture exists as powder, syrup, or compressed tablet.

9. The glucose-containing sweetening mixture according to claim 1, wherein the sweetening mixture has a GSV value between 0.15 and 0.35, the GSV value being calculated according to the formula
$$GSV = \frac{{m}_{Glue}}{{m}_{total}} / SK \qquad [ [ ( I ) ] ]$$
wherein m_{Glu} is the mass of glucose or glucose equivalents contained in the sweetening mixture, wherein mₜₒₜₐₗ is the total mass of the sweetening mixture, and wherein SK is the sweetness of the sweetening mixture.

10. The glucose-containing sweetening mixture according to claim 1, wherein the sweetening mixture comprises between 40% and 60% of the glucose or glucose equivalents compared to that amount of sucrose that would be required to provide a comparable sweetness.

11. A food product comprising a glucose-containing sweetening mixture according to claim 1.

12. The food product according to claim 11, wherein the food product contains 5 to 20 g/kg of the sweetening mixture.

13. The food product according to claim 11, wherein the food product is a beverage.

14. The food product according to claim 11, wherein the food product is free of at least one of sucrose and fructose.

15. The food product according to claim 11, wherein the calorific value of the food product is 80 to 320 kJ/kg.

16. The food product according to claim 11, wherein the calorific value of the food product is 240 to 320 kJ/Kg.

17. The food product according to claim 11, wherein the food product contains 15 to 20 g/kg of the sweetening mixture.

18. The glucose-containing sweetening mixture according to claim 1, wherein the sweetening mixture has a sweetness between 3.5 and 4.5.
